(19) United States
(12) Patent Application Publication
(10) Pub. No.: US 2004/0256751 A1
(43) Pub. Date: Dec. 23, 2004

(54) Compositions for use in making models

(76) Inventor: Jose Walter, Herndon, VA (US)

Correspondence Address: Glenna Hendricks, Esq., P.O. Box 2509, Fairfax, VA, 22031-2509, US

(21) Appl. No.: 10/795,457

(22) Filed: Mar. 9, 2004

Related U.S. Application Data
(63) Continuation-in-part of application No. 10/232,656, filed on Sep. 3, 2002.

(51) Int. Cl. C04B 33/32

(52) U.S. Cl. 264/16; 264/669

(57) ABSTRACT

Gypsum-based molding materials are customized by hydrating the molding material to workable (malleable) consistency with a moistening solution containing 0.001 to 35% polytetrafluoroethylene. The addition of latex results in a more flowable material.

This application is a continuation-in-part of U.S. patent application Ser. No. 10/232,656 filed Sep. 3, 2002. now pending.

### FIELD OF THE INVENTION

This invention relates to compositions for use in making dental models and other molded or shaped objects. The invention provides means for increasing strength of the molded or sculpted objects.

### BACKGROUND OF THE INVENTION

In making models for restoration and replacement in dentistry, it is important that the materials used be both workable and of sufficient strength to provide models that are sharp and do not crumble. It is sometimes necessary to stock various types of materials of varying strength in order to have materials that are optimum for the particular purpose for which the models are made. Models are created using a negative impression of the object of interest. The negative impression is then filled with a casting material which hardens, thus creating a model of the object to be made or modified. In order to work with these models, the casting material must sometimes be sawed into smaller pieces. It is essential to be able to realign the pieces in the appropriate manner and to have materials which hold their shape without crumbling, but which can be worked on and reassembled.

### SUMMARY OF THE INVENTION

It is the purpose of this invention to provide materials for making customized molding material for use in making models. Gypsum-based molding materials are customized by hydrating the molding material to workable (malleable) consistency with a moistening solution containing 0.001 to 35% polytetrafluoroethylene. Other materials which increase other desirable properties such as latexes, which increase flowability, or materials which impart color to the final product may be used in the practice of the invention.

### DETAILED DESCRIPTION OF THE INVENTION

It has now been found that addition of varying amounts of polytetrafluoroethylene (PTFE) to solution for moistening molding materials for making models such as that used in making dental models, especially those containing calcium sulfate (gypsum), will increase strength and sharpness of the models. The gypsum-containing material as used in dentistry is often called “stone”. The amount of PTFE used in a particular application depends on the workability and strength required. When greater amounts of PTFE are used, the material may be harder to work, but will be less likely to crumble. While the materials described herein were developed for purposes of making dental models, the PTFE/gypsum-based molding material may be used for making any models such as those used in manufacturing of parts or packaging. Such applications have wide use in such industries as aerospace, automotive, laboratory and medical equipment industries and in the building industry. The preparation of casting materials for use in making decorative objects is also an aspect of the invention. Such objects may be molded or carved, depending on the work at hand and the preferences of the artisan.

### EXAMPLE 1

Compositions containing 58%-62% PTFE manufactured by Dupont were used in making the following compositions:

| Formula identification | % Dupont PTFE product | % water |
|---|---|---|
| 1 | 0.1% | 99.9% |
| 2 | 0.2% | 99.8% |
| 3 | 0.8% | 99.2% |
| 4 | 8.34% | 91.66% |
| 5 | 16.67% | 83.33% |
| 6 | 33.34% | 66.66% |

To each gallon of formulation, 2 drops of dye were added so that the materials containing the PTFE could be identified. Formulations 1-3, when used to hydrate gypsum-based molding material in place of water usually used for hydration for making dental models produced a resin-like material upon drying. Similar additions of formulations 4-6 resulted in epoxy-like materials. The epoxy-like models were very smooth and hard when dried, but could be cut with appropriate saws to provide very strong models of the teeth. The formulations 1, 2 and 3 contain about 0.05% to 0.5% PTFE. Formulations 4, 5 and 6 contain about 9% to about 20% of the PTFE.

While the instant invention was developed originally for making models of teeth, it may be used in other applications such as making models of parts or openings in materials for which fittings are required to maintain shape.

### EXAMPLE 2

The following formulations were made using a dye which is sold for use in coloring foods:

| Dupont TEFLON T-30 ™ | % water | drops dye/gallon |
|---|---|---|
| 0.1 | 99.9 | 2 |
| 02 | 99.8 | 2 |
| 0.8 | 99.2 | 2 |
| 8.34 | 91.66 | 2 |
| 10.67 | 83.33 | 2 |
| 33.34 | 66.66 | 2 |

In all instances, the use of the resulting product as a moistening agent resulted in molding materials which were colored throughout. The hardness of the final product depended on the amount of TEFLON™ in the moistening agent. The dye chosen will depend on the properties of the dye as required for the particular work. In the instant case, food dye was used for its non-toxic properties and availability. If the materials are to be used for crafts, toxicity would be of paramount importance. For use in decorative items, durability of color may be of paramount importance.

### EXAMPLE 3

It has, furthermore, been found that addition of a latex to the moistening material results in a product that flows more easily. PLEXTOL™ B500 (Cas No. 1336-21-6) and 510 D were obtained from Polymer Latex GmbH & Co. KG of Germany. When using this and similar products (i.e., products having about equivalent setting properties) about 0.01-20 ml could be added per liter of solution. The following compositions were prepared:

| TEFLON T-30 ™ | PLEXTOL ™ | water |
|---|---|---|
| 4 ounces | 64 drops (500B) | 124 ounces |
| 1 ounces | None | 127 ounces |
| 2.56 ounces | 144 drops (510 D) | 125.19 ounces |
| 19.2 ounces | 64 drops (500 B) | 108 ounces |
| 20.8 ounces | 112 drops (500 B) | 107.05 ounces |
| 27.2 ounces | 112 drops (500 B) | 100.65 ounces |

The compositions are listed in order from least to greatest hardness. The last three compositions were quite hard and especially unlikely to crumble when cut. Hence, the workman must consider malleability vs. hardness when choosing the particular moistening agent. (A drop equals about 0.05 ml.) The harder materials are quite useful for us in making building materials for making objects such as cornices, The harder materials are also sometimes more appropriate for making decorative objects or for sculpting.

The choice of the particular latex chosen will also depend on the type of work. For example, a latex which quickly forms a strong, hard coating is less useful for purposes of making a product in instances where malleability is an essential property.

When used to make models, no polymerization step such as heating is needed. Simply moistening the material with a solution containing the desired amount of PTFE will, upon hardening, provide the desired hardness to the models formed when the material is used in accord with the teachings herein.

### EXAMPLE 4

A composition of example 1, the formula identified as formula 2, was used. Gypsum-containing casting material was moistened with the product identified as formula 2 in example 1. A negative impression was filled with the casting material of formula 2 to create a model of the patient's teeth. Once the casting material had hardened sufficiently, the trays and supports with the casting material were removed from the impression and allowed to harden more fully. When the casting material had fully hardened, the tray with the models were removed from the tray support.

### EXAMPLE 5

The process of example 4 was followed using the materials of example 3. The last (hardest) product was most unlikely to crumble, but was also harder to sculpt. However, all of the products were useful for purposes of making models of teeth.

Compositions of the invention may be used in making many objects, including decorative items produced in molds, sculpted or worked with tools commonly used in carpentry, etc. Products such as decorative cornices and pillars are useful for building. While use of dyes in compositions have been exemplified using water-soluble food coloring, other means of coloring such as oil and alcohol soluble coloring agents may be used. Furthermore, for use in making decorative items, small amounts of agents to add interest to the final product such as small colored particles, including finely ground bits of resin or glass, may be incorporated in compositions for use in producing decorative items.

What we claim is:

1. A method of producing a customized hardening molding material comprising the steps of:
1) preparing a solution containing from 0.001 to 35% polytetrafluoroethylene, and
2) by moistening dried molding material with the solution prepared in step 1.

2. The method of claim 1 wherein the molding material contains gypsum.

3. The method of claim 1 wherein the product of step 2 is further used to make dental models.

4. The method of claim 1 wherein the solution prepared in step 1 containing polytetrafluoroethylene is an aqueous solution.

5. The method of claim 1 wherein the solution prepared in step 1 contains 0.05% to 5% polytetrafluoroethylene.

6. The method of claim 1 wherein the solution prepared in step 1 contains 9% to 20% polytetrafluoroethylene.

7. A composition of matter comprising a malleable molding material and a moistening solution containing 0.05% to 20% polytetrafluoroethylene.

8. The composition of claim 7 wherein the moistening solution contains 0.05% to 5% polytetrafluoroethylene and the molding material is gypsum-containing.

9. The composition of claim 7 wherein the moistening solution contains 9% to 20% polytetrafluoroethylene.

10. The composition of claim 7 containing, additionally, a coloring agent.

11. The composition of claim 7 containing, additionally, a latex.

12. The composition of claim 11 containing, additionally, a coloring agent.

13. The method of claim 1 wherein, in step 1, there is, additionally, added a latex.

14. The composition of claim 7 containing a latex.

15. The composition of claim 14 containing 0.01 to 20 ml of a latex per liter.

16. A composition of claim 7 which is in the form of a dental model.
